(19) United States
(12) Patent Application Publication
(10) Pub. No.: US 2014/0272307 A1
(43) Pub. Date: Sep. 18, 2014

(54) FOAM DUCT TAPE

(71) Applicant: ShurTech Brands, LLC, (US)

(72) Inventor: Timothy Sas, North Ridgeville, OH (US)

(73) Assignee: ShurTech Brands, LLC, Avon, OH (US)

(21) Appl. No.: 13/797,422

(22) Filed: Mar. 12, 2013

(51) Int. Cl. C09J 7/02; B32B 3/30; B32B 7/12; B32B 5/24

(52) U.S. Cl. CPC C09J 7/0296; B32B 5/245; B32B 3/30; B32B 7/12
USPC 428/159; 156/324; 156/73.1; 264/45.9; 442/1

(57) ABSTRACT

An adhesive tape comprises a duct tape layer and a foam mounting tape layer. The duct tape layer comprises a polymer layer having a top surface and a bottom surface, a scrim, and an adhesive layer between the polymer layer and the scrim. The foam mounting tape layer comprises a foam layer having a top surface and a bottom surface, an optional adhesive layer on the top surface of the foam layer, and an adhesive layer on the bottom surface of the foam layer. The foam layer has a thickness in a range of about 0.01 inch to 0.75 inch. The adhesive tape optionally has a scrim arranged on a bottom surface of the foam mounting tape layer. The foam layer of the foam mounting tape layer is optionally embossed in a predetermined pattern to impart a pattern to the top surface of the adhesive tape.

### FIELD OF THE INVENTION

The present invention relates to an adhesive tape, more particularly to a foam duct tape.

### BACKGROUND OF THE INVENTION

There are numerous adhesive tapes in the marketplace. One such tape is duct tape which is known for its high level of adhesive strength. Duct tape typically is relatively thin having a thickness in a range of 5 mils to 12 mils. Duct tape can be torn by hand but when unrolled it has a tendency to adhere to itself.

Although consumers have used traditional duct tape for numerous purposes, there is a need for an alternative adhesive tape that has certain of the features of duct tape such as its durability and ability to tear by hand, but yet provides a different texture, appearance, and functionality, particularly for those in the field of arts and crafts. The present invention addresses and provides a solution for this unmet need.

### SUMMARY OF THE INVENTION

The present invention relates to an adhesive tape and a method of making the same.

In an aspect of the present invention, the adhesive tape comprises a duct tape layer and a foam mounting tape layer. The duct tape layer comprises a polymer layer having a top surface and a bottom surface, a scrim below the bottom surface of the polymer layer, and an adhesive layer between the polymer layer and the scrim. The foam mounting tape layer comprises a foam layer having a top surface and a bottom surface, and an adhesive layer on the bottom surface of the foam layer. The foam layer has a thickness in a range of about 0.01 inch to 0.75 inch. An optional adhesive is present on the top surface of the foam layer.

In another aspect of the present invention, the adhesive tape comprises a duct tape layer, a foam mounting layer, and a scrim. The duct tape layer comprises a polymer layer having a top surface and a bottom surface, a scrim below the bottom surface of the polymer layer, and an adhesive layer between the polymer layer and the scrim. The foam mounting layer comprises a foam layer having a top surface and a bottom surface, and an adhesive layer on the bottom surface of the foam layer. The foam mounting layer optionally comprises an adhesive layer on the top surface of the foam layer. A scrim is arranged on the bottom surface of the foam mounting tape layer.

In another aspect of the present invention the adhesive tape comprises a duct tape layer and a foam mounting tape layer wherein a foam layer of the foam mounting tape layer has an embossed top surface. The duct tape layer comprises a polymer layer having a top surface and a bottom surface, a scrim below the bottom surface of the polymer layer, and an adhesive layer between the polymer layer and the scrim. The foam mounting tape layer comprises a foam layer having an embossed top surface and a bottom surface, and an adhesive layer on the bottom surface of the foam layer.

In still yet another aspect of the present invention, a method of making the foam duct tape is provided. The method comprises providing a duct tape layer, providing a foam mounting layer, relaxing the duct tape layer to eliminate tension in the duct tape layer, and laminating the duct tape layer to the foam mounting layer.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 illustrates a cross-sectional view of an adhesive tape in accordance with aspects of the present invention.

FIG. 2 illustrates a cross-sectional view of another adhesive tape in accordance with aspects of the present invention.

FIG. 3 illustrates a cross-sectional view of an embossed adhesive tape in accordance with aspects of the present invention.

FIG. 4 illustrates a system and method for manufacturing foam duct tape in accordance with aspects of the present invention.

### DETAILED DESCRIPTION OF THE INVENTION

The following detailed description of the embodiment(s) is merely exemplary in nature and is in no way intended to limit the invention, its application, or uses.

Referring to the figures, FIG. 1 illustrates a cross-sectional view of an adhesive tape in accordance with aspects of the present invention. As shown in FIG. 1, the adhesive tape 100 comprises at least two layers: a duct tape layer 140 and a foam mounting tape layer 150.

The duct tape layer 140 comprises a polymer layer 110, an adhesive layer 120, a scrim 130. Examples of commercially available duct tapes include the DUCK® brand duct tape of ShurTech Brands, LLC.

The foam mounting layer 150 comprises a foam layer 170 having a top surface and a bottom surface, a first adhesive layer 160 on the top surface of the foam layer, and a second adhesive layer 180 on the bottom surface of the foam layer.

Examples of polymeric materials that are suitable as the polymer layer 110 include, but are not limited to, polyester, nylon, polyethylene, vinyl, and other synthetic polymers. Preferably, the polymeric material is polyethylene. It is also preferable that the polymeric material is waterproof.

Examples of adhesives for adhesive layer 120 include, but are not limited to, pressure sensitive adhesives including those having low and high tack, rubber based adhesives (synthetic and natural), acrylic adhesive, hot melt adhesive, microsphere adhesive, and any other adhesive suitable for use in duct tape construction.

Examples of materials that are suitable for the scrim 130 include, but are not limited to, natural materials, synthetic materials, or combinations thereof. Examples of natural materials include, but are not limited to, cotton, cotton blends, silk, hemp, flax, and combinations thereof. Examples of synthetic materials include, but are not limited to, polypropylene, polyester, nylon, polyethylene, or combinations thereof. Natural materials are optionally treated or coated with synthetic materials. The scrim is in a form of a cloth, mesh, non-woven, or fabric. The scrim optionally comprises a pigment or a dye.

The polymer layer 110, adhesive layer 120, a scrim 130 are combined together to form a duct tape layer using a number of possible methods. One such method uses a calendar laminating process during which the layers are made separately and then laminated together under pressure. An alternative method involves ejecting polyethylene pellets onto a thin film, then blending the film with the scrim while the plastic is hot, and then spreading the adhesive onto the film.

The adhesive tape 100 of the present invention is preferably colored. Methods by which to provide a colored adhesive tape 100 include, but are not limited to, coloring the duct tape layer 140 or coloring the foam mounting tape layer 150. In the case of coloring the duct tape layer, the polymer layer 110 comprises a pigment or a dye. For example, the polyethylene film of the duct tape preferably comprises a pigment or a dye. For example, a co-extrusion process utilizes colored polyethylene pellets (i.e. pellets comprising a pigment or a dye). The polyethylene film is then combined with a scrim and coated with an adhesive such as a rubber based pressure sensitive adhesive. In the case of a colored foam mounting tape, the foam layer comprises a pigment or a dye.

Examples of adhesives for adhesive layers 160 and 180 include, but are not limited to, pressure sensitive adhesives including those having low and high tack, rubber based adhesives (synthetic and natural), acrylic adhesive, hot melt adhesive, and microsphere adhesive. The adhesive of each of layers 160 and 180 are selected to be the same or different. High tack typically refers to a permanent adhesive and low tack typically refers to a removable adhesive.

The types of materials that are suitable for the foam layer 170 include, but are not limited to, polyethylene, polyurethane, foam rubber, vinyl foam, flexible vinyl foam, urethane foam and clear urethane foam. An example of suitable polyurethane foam includes, but is not limited to, visco-elastic polyurethane foam (referred to as memory foam).

Although FIG. 1, illustrates the foam layer 170 having an adhesive layer 160, 180 on the respective top and bottom surfaces of the foam layer 170, in some instances the adhesive layer(s) may be optional depending upon the method by which the structure is manufactured.

The thickness of the foam layer 170 is in a range of about 0.01 inch to 0.75 inch, preferably in a range of about 0.06 inch to 0.4 inch. The thickness of the foam layer 170 is an important feature of the adhesive tape of the present invention as it provides the adhesive tape 100 with a three-dimensional effect. The thickness of the foam layer 170 also provides the adhesive tape with a soft touch effect that is desirable from an aesthetic standpoint, particularly for use of the adhesive tape in the field of arts and crafts, and more particularly in the field of arts and crafts for children who are developing hand dexterity. The thickness of the tape is a differentiating factor from other tapes such as in U.S. Patent Publication No. 2012/0028524 in which the foam is intended to be extremely thin such as in the range of mils and is an imperceptible attribute of the duct tape.

In another aspect of the present invention, the soft touch adhesive tape 100 is removable. An example of such a foam mounting tape layer comprises a 0.01 inch to 0.75 inch thick polyethylene foam layer with a low-tack rubber based adhesive on the bottom surface of the polyethylene foam layer. The foam layer is clear or of any color. The top layer can be either low-tack or high-tack rubber based adhesive. The foam mounting tape layer is removable without any residue and adheres to most dry and clean surfaces. The polyethylene foam layer is optionally coated or treated on each side with a pressure sensitive adhesive including those having low tack, rubber based adhesive (synthetic and natural), acrylic adhesive, hot melt adhesive, and microsphere adhesive. The foam mounting tape layer optionally has a silicone coated release liner. A release liner is to be removed during the manufacturing of the final adhesive tape product.

In another aspect of the present invention, the foam mounting tape layer 150 is suitable for permanent or long term use. An example of such a foam mounting tape comprises a 0.01 inch to 0.75 inch thick polyethylene foam layer with a high-tack rubber based adhesive on the top and bottom surfaces of the polyethylene foam layer. The foam layer is clear or of any color. The adhesive is highly aggressive in terms of degree of adhesion and allows for high shear objects. The foam mounting tape layer conforms to applied surfaces and is intended for the permanent or long term use. The foam mounting tape layer adheres to most dry and clean surfaces. The polyethylene foam layer is optionally coated on each side with a solvent synthetic rubber based pressure sensitive adhesive, rubber based adhesive (synthetic and natural), acrylic adhesive, hot melt adhesive, microsphere adhesive, or other adhesive. The foam mounting tape optionally has a silicone coated release liner. A release liner is to be removed during the manufacturing of the final adhesive tape product.

To form the adhesive tape 100 of the present invention, the duct tape layer 140 and the foam mounting tape layer 150 are combined. There are numerous methods by which the duct tape layer 140 and the foam mounting tape layer 150 are combined, either in a permanent or removable manner.

Examples of methods by which the duct tape layer 140 and the foam mounting tape layer 150 are combined include, but are not limited to, laminating the duct tape layer 140 to the foam mounting tape layer 150, co-extruding the duct tape layer 140 and the foam mounting tape layer 150, adhering the duct tape layer 140 to the foam mounting tape layer 150 using an adhesive, and incorporating the foam layer within the duct tape structure.

In an aspect of the present invention, the foam layer 170 is incorporated within the duct tape structure. The method comprises, preferably at ambient temperature ranging from 50° F. to 100° F., combining polyethylene film with the scrim and laminating onto the foam layer 170 as the polyethylene film is being laminated to the scrim.

A laminating machine unwinds the duct tape and releases any tension by creating a loop, which is controlled by an ultrasonic sensor. The ultrasonic sensor generates high frequency sound waves and evaluates the echo, which is received back to the ultrasonic sensor. The ultrasonic sensor calculates the time interval between sending the signal and receiving the echo and determines the measured distance to an object. The ultrasonic sensor then sends a signal to the speed control of the motor, that drives the duct tape layer. The feedback signal from the ultrasonic sensor controls the size of the loop of duct tape layer.

The foam with or without adhesive on one or both sides enters with or without a release liner on one or both sides. Any release liner is removed during processing. The foam layer is combined with the duct tape. The finished tape product optionally contains a release liner. The resulting tape product is a soft touch color adhesive tape in accordance with the present invention. The adhesive tape is slit into any desired slit width for rolls or laminated to a liner for individual sheets.

FIG. 2 illustrates a cross-sectional view of a tape in accordance with an aspect of the present invention wherein the adhesive tape has two scrims. Referring to FIG. 2, the tape 200 comprises a polymer layer 210, adhesive layer 220 and cloth mesh or scrim 230 forming a duct tape 240. Adhesive layer 260, foam layer 270, and adhesive layer 280 form a foam mounting tape 250. A second scrim 290 laminated to the foam layer 270 which is adjacent to the adhesive layer 280. The duct tape 240 and the foam mounting tape 250 are combined by co-extruding the duct tape 240 and the foam mounting tape 250 together, laminating the duct tape 240 and the foam mounting tape 250 together, adhering the duct tape 240 and the foam mounting tape 250 together using an adhesive, incorporating the foam layer 270 within the duct tape structure, or combining by another method.

A second scrim is affixed by an adhesive or is laminated. Examples of materials that are suitable for the scrim include, but are not limited to, natural materials, synthetic materials, or combinations thereof. Examples of natural materials include, but are not limited to, cotton, cotton blends, silk, hemp, flax, and combinations thereof. Examples of synthetic materials include, but are not limited to, polyester, nylon, polyethylene, vinyl, fiberglass, and other synthetic polymers. Examples of coated materials that are suitable for the scrim include, but are not limited to, cotton, cotton blends, silk, hemp, flax, and combinations thereof coated with polyester, nylon, polyethylene, and other synthetic polymers. Examples of a blend of natural and/or synthetic materials include, but are not limited to, cotton, cotton blends, silk, hemp, flax, and combinations thereof, blended with synthetic materials which include, but are not limited to, polyester, nylon, polyethylene, and other synthetic polymers, vinyl, and fiberglass.

The scrim is in a form of a cloth, mesh, non-woven, or fabric. The adhesive tape of the present invention is not limited to a tape having one or two scrims. The scrim optionally comprises a pigment or a dye.

Referring to the figures, FIG. 3 illustrates a cross-sectional view of an embossed adhesive tape 300 in accordance with aspects of the present invention. As shown in FIG. 3, the adhesive tape 300 is embossed and has a visible raised, three-dimensional effect on the top surface A of the adhesive tape 300. In a preferred aspect of the present invention, the foam layer 370 of the foam mounting tape layer 350 has an embossed top surface B. As a result, a visible, three-dimensional effect is achieved on the top surface A of the adhesive tape 300. This feature is achieved, for example, by embossing or imparting a predetermined pattern on the top surface B of the foam layer 370 before laminating or combining the duct tape layer 340 with the foam mounting tape layer 350 in order to transfer the physical characteristics to the duct tape layer 340 and to impart them to the top surface A of the adhesive tape 300. Any foam layer 370 having an embossed surface is suitable to be used to provide this effect when combined with the duct tape layer 340. The top surface A of the adhesive tape 300 mirrors the embossed or patterned surface of the foam mounting tape layer 350.

The adhesive tape of the present invention thus is durable yet soft and pliable. The adhesive tape is tearable by hand or cuttable with scissors.

In another aspect of the present invention, referring to FIG. 4, a system and method of making the foam duct tape of the present invention is provided to eliminate curling of the foam duct tape. The method generally comprises providing a duct tape layer 410, providing a foam mounting layer 420, relaxing the duct tape layer 410 using an ultrasonic sensor 440 to eliminate tension in the duct tape layer 410, and laminating the duct tape layer 410 to the foam mounting layer 420.

An ultrasonic sensor 440 is used to relax the duct tape layer 410 prior to lamination with the foam mounting layer 420. A non-obvious aspect of the method of the present invention to overcome the problem of curling of the foam duct tape is to laminate the foam mounting layer 420 under a condition of equilibrium and without tension on either the duct tape layer 410 or the foam mounting layer 420.

Thus, an issue to address when manufacturing the foam duct tape is the amount of tension on the web of the duct tape and the roller pressure of the laminating rollers. In order to properly relax the duct tape layer, a bow roller 430 is installed prior to the ultrasonic sensor 440. The bow roller 430 properly stretches the web of the duct tape layer 410 before entering a relaxed loop state as shown in FIG. 4. This eliminates the tension and thereby decreases the curling effect on the foam duct tape. The ultrasonic sensor 440 controls a loop prior to laminating the duct tape layer 410 to the mounting tape layer 420. Thus, the method comprises laminating the foam mounting layer 420 under the condition that both layers are without tension and in a state or condition of equilibrium and joining them together at a temperature between 65° F. and 85° F.

Proper adjustment of the tension also eliminates any wrinkles during the manufacturing of the foam duct tape. Besides joining both layers together under an equilibrium condition or state to control the curling effect, the frictional bonding forces between the web and lamination rollers causes wrinkling or bending. Bending of the material is directly proportional to the thickness of the material and a function of tensioning. The wrinkles are controlled by lowering the speed of the web of the duct tape, thereby reducing the potential of wrinkles caused by entrapped air.

As shown in FIG. 4, a crown roller 460 is installed prior to die cutting station 470. The crown roller is used to eliminate any residual wrinkles prior to cutting the foam tape product 500. While laminating the duct tape layer and the foam mounting layer, the materials are cooled to between 65° F. and 85° F., at the point of lamination, to eliminate any thermal expansion, which causes wrinkles. The lamination rollers 450 are chilled and maintained at between about 65° F. and 85° F.

Thus, the foam duct tape of the present invention provides numerous benefits and advantages over other adhesive tapes including, but not limited to, its three-dimensionality, strength, stiffness, reduced likelihood to adhere to itself, and ability to float. Thus, it is suitable for use in numerous end use applications such as arts and crafts but also for uses where there is a need for protective padding such as cushioned grips for hammers, baseball bats, rakes, bicycle handles, among others.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. An adhesive tape comprising:
a duct tape layer comprising a polymer layer having a top surface and a bottom surface, a scrim below the bottom surface of the polymer layer, and an adhesive layer between the polymer layer and the scrim, and
a foam mounting tape layer comprising a foam layer having a top surface and a bottom surface, and an adhesive layer on the bottom surface of the foam layer.

2. The adhesive tape according to claim 1, wherein the foam layer has a thickness in a range of about 0.01 inch to 0.75 inch.

3. The adhesive tape according to claim 1, wherein an adhesive layer is on the top surface of the foam layer.

4. The tape according to claim 1, wherein the adhesive layer on the top surface of the foam layer is a pressure sensitive adhesive, rubber based adhesive, acrylic adhesive, hot melt adhesive, or microsphere adhesive.

5. The tape according to claim 4, wherein the rubber based adhesive comprises a synthetic rubber.

6. The tape according to claim 4, wherein the rubber based adhesive comprises a natural rubber.

7. The tape according to claim 1, wherein the duct tape layer is laminated to the foam mounting tape layer.

8. The tape according to claim 1, wherein the duct tape layer is co-extruded with the foam mounting tape layer.

9. The tape according to claim 1, wherein the duct tape layer and the foam mounting tape layer are combined with an adhesive.

10. The tape according to claim 1, wherein the foam layer comprises a polymer.

11. The tape according to claim 10, wherein the polymer is selected from the group consisting of polyester, nylon, vinyl, polyethylene, or other synthetic polymer.

12. The tape according to claim 1, wherein the adhesive layer on the bottom surface of the foam layer is a pressure sensitive adhesive, rubber based adhesive, acrylic adhesive, hot melt adhesive, or microsphere adhesive.

13. The tape according to claim 12, wherein the rubber based adhesive comprises a synthetic rubber.

14. The tape according to claim 12, wherein the rubber based adhesive comprises a natural rubber.

15. The tape according to claim 1, wherein the adhesive tape comprises a pigment or a dye.

16. The tape according to claim 1, wherein the scrim comprises a pigment or a dye.

17. The tape according to claim 1, wherein the duct tape layer of the adhesive tape comprises the pigment or the dye.

18. The tape according to claim 1, wherein the foam mounting layer of the adhesive tape comprises the pigment or the dye.

19. An adhesive tape comprising:
a duct tape layer comprising a polymer layer having a top surface and a bottom surface, a scrim below the bottom surface of the polymer layer, and an adhesive layer between the polymer layer and the scrim, and
a foam mounting tape layer having a top surface and a bottom surface, the foam mounting tape layer comprising a foam layer having a top surface and a bottom surface, and an adhesive layer on the bottom surface of the foam layer, and
a scrim arranged on the bottom surface of the foam mounting tape layer.

20. The adhesive tape according to claim 19, wherein an adhesive layer is on the top surface of the foam layer.

21. The adhesive tape according to claim 18, wherein the foam layer of the foam mounting tape layer has a thickness in a range of about 0.01 inch to 0.75 inch.

22. An adhesive tape comprising:
a duct tape layer comprising a polymer layer having a top surface and a bottom surface, a scrim below the bottom surface of the polymer layer, and an adhesive layer between the polymer layer and the scrim, and
a foam mounting tape layer comprising a foam layer having a top surface and a bottom surface, and an adhesive layer on the bottom surface of the foam layer, and
wherein the foam layer of the foam mounting tape layer has an embossed top surface.

23. The adhesive tape according to claim 22, wherein an adhesive layer is on the top surface of the foam layer.

24. The adhesive tape according to claim 22, wherein the foam layer has a thickness in a range of about 0.01 inch to 0.75 inch.

25. The tape according to claim 22, wherein the foam layer comprises a polymer.

26. The tape according to claim 25, wherein the polymer is selected from the group consisting of polyester, nylon, polyethylene, vinyl, and other synthetic polymers.

27. The tape according to claim 23, wherein the adhesive layer on the top surface of the foam layer is a pressure sensitive adhesive, rubber based adhesive, acrylic adhesive, hot melt adhesive, or microsphere adhesive.

28. The tape according to claim 27, wherein the rubber based adhesive comprises a synthetic rubber.

29. The tape according to claim 27, wherein the rubber based adhesive comprises a natural rubber.

30. The tape according to claim 22, wherein the adhesive layer on the bottom surface of the foam layer is a pressure sensitive adhesive, rubber based adhesive, acrylic adhesive, hot melt adhesive, or microsphere adhesive.

31. The tape according to claim 30, wherein the rubber based adhesive comprises a synthetic rubber.

32. The tape according to claim 30, wherein the rubber based adhesive comprises a natural rubber.

33. The tape according to claim 22, wherein the adhesive tape comprises a pigment or a dye.

34. The tape according to claim 33, wherein the duct tape layer of the adhesive tape comprises the pigment or the dye.

35. The tape according to claim 33, wherein the foam mounting layer of the adhesive tape comprises the pigment or the dye.

36. The tape according to claim 33, wherein the scrim of the adhesive tape comprises the pigment or the dye.

37. The tape according to claim 22, wherein the adhesive tape has an embossed top surface.

38. The tape according to claim 37, wherein the embossed top surface is in a predetermined pattern.

39. The tape according to claim 22, wherein the adhesive tape has an embossed top surface with a top layer of a pressure sensitive adhesive, rubber based adhesive, acrylic adhesive, hot melt adhesive, or microsphere adhesive.

40. A method of making a foam duct tape, the method comprising:
providing a duct tape layer,
providing a foam mounting layer,
relaxing the duct tape layer to eliminate tension in the duct tape layer, and
laminating the duct tape layer to the foam mounting layer.

41. The method according to claim 40, wherein an ultrasonic sensor is used to relax the duct tape layer.

42. The method according to claim 40, wherein the ultrasonic sensor controls a loop prior to laminating the duct tape layer to the mounting tape layer.

43. The method according to claim 40, further comprising stretching the duct tape layer prior to laminating.

44. The method according to claim 40, wherein a bow roller is used to stretch the duct tape layer.

45. The method according to claim 44, wherein the bow roller is installed before an ultrasonic sensor.

46. The method according to claim 40, wherein laminating the foam mounting layer occurs when the duct tape layer and the foam mounting layer are both without tension or in a state or condition of equilibrium.

47. The method according to claim 40, further comprising cooling a lamination roller to a temperature between 65° F. and 85° F.

48. The method according to claim 40, wherein laminating occurs at a temperature between 65° F. and 85° F.

49. The method according to claim 40, further comprising lowering the speed of a web of the duct tape layer to eliminate wrinkles.

50. The method according to claim 40, further comprising cutting the foam duct tape.

51. The method according to claim 40, using a crown roller on the foam duct tape prior to cutting the foam duct tape.
